(19) United States
(12) Patent Application Publication
(10) Pub. No.: US 2025/0299895 A1
(43) Pub. Date: Sep. 25, 2025

(54) OVERLOAD PROTECTION SWITCH WITH SHORT CIRCUIT PROTECTION FUNCTION

(71) Applicants: Yi-Hsiang WANG, Taoyuan City (TW); I-Ying WANG, Taoyuan City (TW)

(72) Inventors: Yi-Hsiang WANG, Taoyuan City (TW); I-Ying WANG, Taoyuan City (TW)

(21) Appl. No.: 18/609,971

(22) Filed: Mar. 19, 2024

(51) Int. Cl. H01H 23/16; H01H 23/04

(52) U.S. Cl. CPC H01H 23/16; H01H 23/04

(57) ABSTRACT

An overload protection switch with a short circuit protection function that has U-shaped hollow part of the binary alloy conductive plate which closed to the fixed end, at least one lead facing the first connecting point, and the inner end of the lead is in a state of being close to but not in contact with the spring leaf and the first connecting point, thereby forming an end receiving the electric arc generated by the first connecting point for making the electric arc leave through the absorption channel formed by the closest lead.

### BACKGROUND OF THE INVENTION

### 1. Field of the Invention

The present invention relates to an overload protection switch with short circuit protection function, particularly to one that uses a binary alloy conductive plate to shift the conductive position in advance when a short circuit trip occurs, discharges the short circuit current through the lead and terminates it, and subsequently generates an electric arc to significantly reduce the arc time and arc size. In addition to reduce the loss of the connecting point, and because the lead absorbs the arc damage, it can avoid the damage caused by tripping to the binary alloy conductive plate, so as to achieve a structural improvement avoid short circuit damage.

### 2. Description of the Related Art

Low-voltage circuit breaker, Europe and America call molded-case circuit breaker (MCCB) is a low-voltage over-current protection circuit breaker with a solenoid valve structure combined with a binary alloy conductive plate. Compared with miniature circuit breaker (MCB) which only has a binary alloy conductive plate, molded-case circuit breaker does not trip through the binary alloy conductive plate when is heated and delayed in the event of a short circuit. Instead, the voltage drop during the short circuit triggers the solenoid valve to act and trip instantaneously. The MCB uses the binary alloy conductive plate that is heated and bent to delay the trip, so it only has overload delay trip function, and because the binary alloy conductive plate cannot trip instantly during a short circuit, the binary alloy conductive plate is damaged, so that the tripping characteristics will be changed, and the non-damaged effect cannot be achieved.

FIGS. 1A and 1B disclose a conventional overcurrent protection switch 10 comprises a housing 11 with a switching component (seesaw lampshade) 12 on the top, a first terminal 12a, a second terminal 12b, a third terminal 12c separately arranged at the bottom for providing power for neon lamp 15. The first terminal 12a has a bimetal plate 13 and a first contact 131; the second terminal 12b has a second contact 121 corresponding to the first contact 131. The moving element 14 has one end linking the bottom of the switching component 12 and the other linking the moving terminal of the bimetal plate 13, whereby the pressing of the switching component 12 actuates the first contact 131 connecting to the second contact 121 and therefore turns on the device; while overcurrent occurs, the bimetal plate 13 deforms due to high degree of temperature and disconnects the first and second contact 131, 121, turning off the device so as to form an overcurrent protection switch 10.

FIGS. 2A and 2B disclose U.S. Pat. No. 11,501,941, the prior patent of the inventor, an overload protection switch with reverse restart switching structure, and referring to FIGS. 3A˜3B disclose U.S. Pat. No. 18,477,216, the prior patent of the inventor, the first terminal 40 is connected to a binary alloy conductive plate 41, the inner side of the movable end 411 of the binary alloy conductive plate 41 extends a spring leaf 42, above the movable end 411 having a first connecting point 421, and the second terminal 50 having a second connecting point 511 on the surface of an upper section 51 thereof corresponding to the first connecting point 421; Wherein FIGS. 2A and 3A show the movable end 411 of the binary alloy conductive plate 41 is curved in down concave arc shape 411b, for making the spring leaf 42 to bounce upward; Wherein FIGS. 2B and 3B show the movable end 411 of the binary alloy conductive plate 41 is curved in up concave arc shape 411a, for making the spring leaf 42 to bounce downward.

Among the previous cases disclosed above, there is still something that is not perfect, that is, when the first connecting point 421 and the second connecting point 511 trip and separate in a short circuit, the generated short circuit electric arc cannot be shorten the time and reduce the size, both the connecting point and the binary alloy conductive plate 41 are damaged, and the function of non-damaged effect during short circuit cannot be achieved.

Thus, finding a way to use a short circuit current discharge device to significantly reduce the size and arc time of the electric arc, thereby reducing the loss of the connecting point and avoiding the damage to the characteristics of the binary alloy conductive plate, and achieving an improved structure that is non-damaged effect during short circuit, is the present invention main goal.

### SUMMARY OF THE INVENTION

A primary object of the present invention is to provide an improved structure of miniature circuit breaker (MCB) which has an overload protection switch with short circuit protection function that can discharge the short-circuit current in advance by shifting the conductive position and the subsequent arc generation can be terminated to reduce the short circuit arc time and the size of the short circuit arc. In addition to reducing the loss of the connecting point, the leads are used to absorb the short circuit arc, so it can prevent the tripping characteristics of the binary alloy conductive plate be damaged, and the non-damaged effect is improved.

To achieve the objects mentioned above, the present invention comprises a housing, having a switching component on the top, a first terminal and a second terminal; the first terminal is connected to a binary alloy conductive plate, an inner side of the binary alloy conductive plate has a U-shaped hollow part, making the binary alloy conductive plate has a spring leaf, the spring leaf has a through hole for riveting a rivet post of a first connecting point, and the second terminal has a second connecting point on a surface of an upper section thereof disposed in correspondence with the first connecting point; a moving rod arranged inside the housing and is driven by the switching component to link the binary alloy conductive plate for the first connecting point to contact the second connecting point, to thereby achieve a conducting state (ON), and the first connecting point disconnecting from the second connecting point responsive to occurrence of a current overload wherein the binary alloy conductive plate deforms due to high temperature, and thereby achieving a nonconducting state (OFF), to thereby form an overcurrent protection switch; wherein: the spring leaf is formed at the movable end of the binary alloy conductive plate and extends from the inner side thereof, and an equidistant space is formed between the left and right inner sides of the binary alloy conductive plate, so that when the current is overloaded, the spring leaf can smoothly bounce and deform on the binary alloy conductive plate; furthermore, at the position relative to the first connecting point of the U-shaped hollow part of the binary alloy conductive plate which closed to the fixed end, at least one lead facing the first connecting point, and the inner end of the lead is in a state of being close to but not in contact with the spring leaf and the first connecting point, thereby forming an end receiving the electric arc generated by the first connecting point for making the electric arc leave through the absorption channel formed by the closest lead; furthermore, the equidistant space between the inner sides of the binary alloy conductive plate and the spring leaf is greater than the distance between the inner end of the lead and the spring leaf and the first connecting point, so that the electric arc (E) generated by the first connecting point absorbs and moves away in advance through the lead, since the distance from the second connecting point becomes farther during moving up and down.

Also, the first connecting point is set through the through hole by a rivet post, then riveted into a parallel thin body with an outer diameter greater than 3 mm and less than 4 mm, with a thickness greater than 0.2 mm and less than 0.5 mm, then using a small punch-pin to squeeze to form a down concave arc surface that can fill the inner diameter of the through hole.

With the features above mentioned, by the inner end of the lead and the first connecting point which is close to but not in contact with the spring leaf, the present invention does not need to change the structure of the original connecting point separation structure, then the present invention can make the short circuit arc leaver through the absorption channel formed by the closest lead, so the original short circuit arc between the two connecting points disappears, and there is no current conduction function, and there is no continuous short circuit arc to damage the first connecting point, the second connecting point and the binary alloy conductive plate. Therefore, it is a device that uses the transfer of the conductive position to smoothly discharge the current to eliminate the arc. It can shorten the time and distance of the arc to reduce the loss of the first connecting point, the second connecting point and the binary alloy conductive plate, so as to achieve a non-damaged short circuit effect.

### BRIEF DESCRIPTION OF THE DRAWINGS

FIG. 1A is a perspective view of an overcurrent protection switch according to the prior art;

FIG. 1B is a section view of an overcurrent protection switch according to the prior art;

FIG. 2A is a perspective view of the U.S. Pat. No. 11,501,941 when the binary alloy conductive plate is curved downward;

FIG. 2B is a perspective view of the U.S. Pat. No. 11,501,941 when the binary alloy conductive plate is curved upward;

FIG. 3A is a side sectional view of the switch of the patent Ser. No. 18/477,216 when switching to ON state;

FIG. 3B is a side sectional view of the switch of the patent Ser. No. 18/477,216 when switching to OFF state;

FIG. 4A is an exploded view of the preferred embodiment of the present invention;

FIG. 4B is an exploded view of the binary alloy conductive plate and the first terminal of the present invention;

FIG. 4C is a schematic diagram illustrating the binary alloy conductive plate and the spring leaf of the present invention;

FIG. 5A is a perspective view of the binary alloy conductive plate and the first terminal of the present invention, showing the first connecting point and the second connecting point are contacted;

FIG. 5B is a perspective view of the binary alloy conductive plate and the first terminal of the present invention, showing the first connecting point and the second connecting point are separated;

FIG. 6 is an exploded view of the housing and the side cover of the present invention;

FIG. 7 is a perspective view of the preferred embodiment of the present invention;

FIG. 8 is a sectional view of the preferred embodiment of the present invention, when is in TRIP status;

FIG. 9 is a sectional view of the preferred embodiment of the present invention, when is in ON status;

FIG. 10 is a sectional view of the preferred embodiment of the present invention, when is in OFF status;

FIG. 11A is a side view of the present invention when the first connecting point and the second connecting point are separated;

FIG. 11B is a side view of the present invention when the first connecting point and the second connecting point are contacted;

FIG. 12A is a schematic diagram illustrating the electric arc of the present invention when the first connecting point and the second connecting point are contacted;

FIG. 12B is a schematic diagram illustrating the electric arc of the present invention when the first connecting point and the second connecting point are just separated;

FIG. 12C is a schematic diagram illustrating the stretching of the electric arc of the present invention;

FIG. 12D is a schematic diagram illustrating the leaving of the electric arc of the present invention;

FIG. 13A is a schematic diagram illustrating the electric arc if without the guiding of the lead of the present invention;

FIG. 13B is a schematic diagram illustrating a rivet post set through the through hole of the present invention;

FIG. 13C is a schematic diagram illustrating the rivet post of the present invention being riveted and squeezed;

FIG. 14A is a schematic diagram illustrating the electric flow without generating the electric arc of the present invention when the first connecting point and the second connecting point are just contacted;

FIG. 14B is a schematic diagram illustrating the electric flow of the present invention when the first connecting point and the second connecting point are separated.

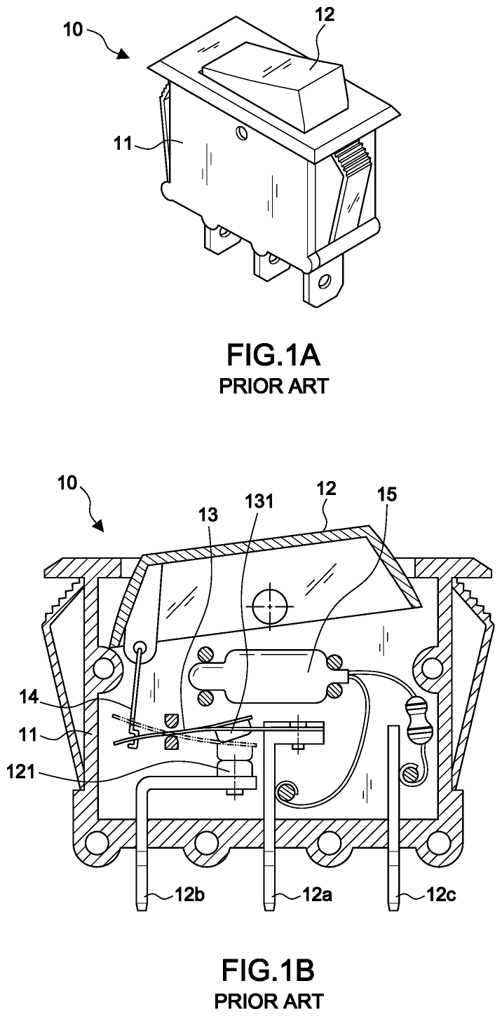

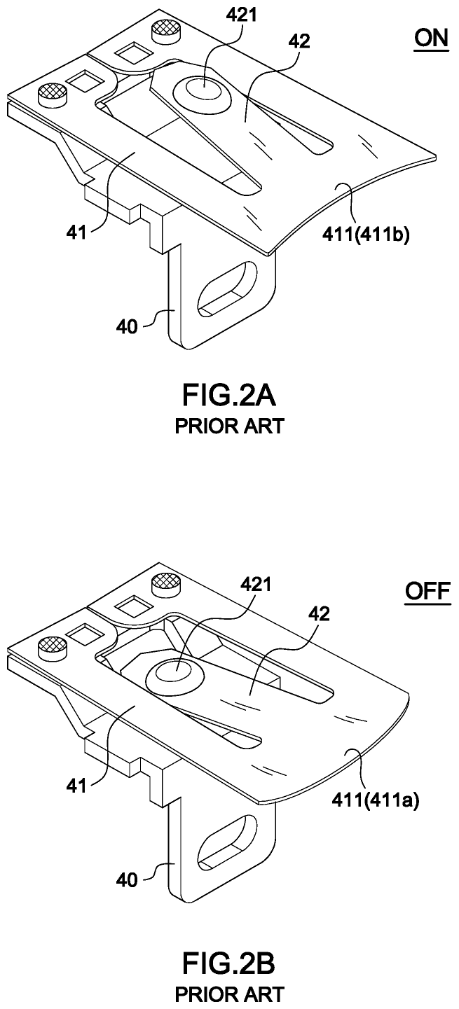

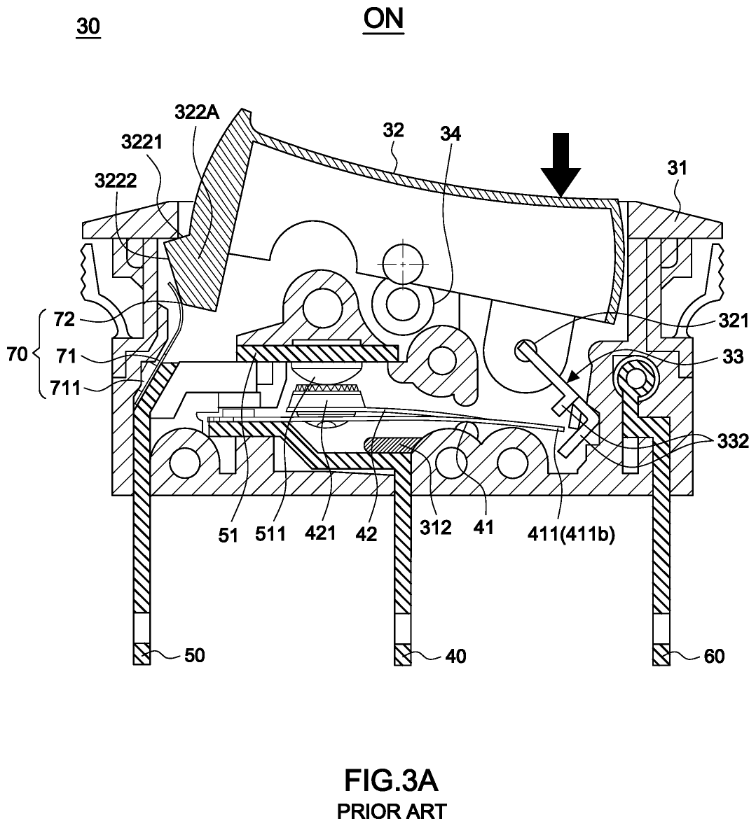

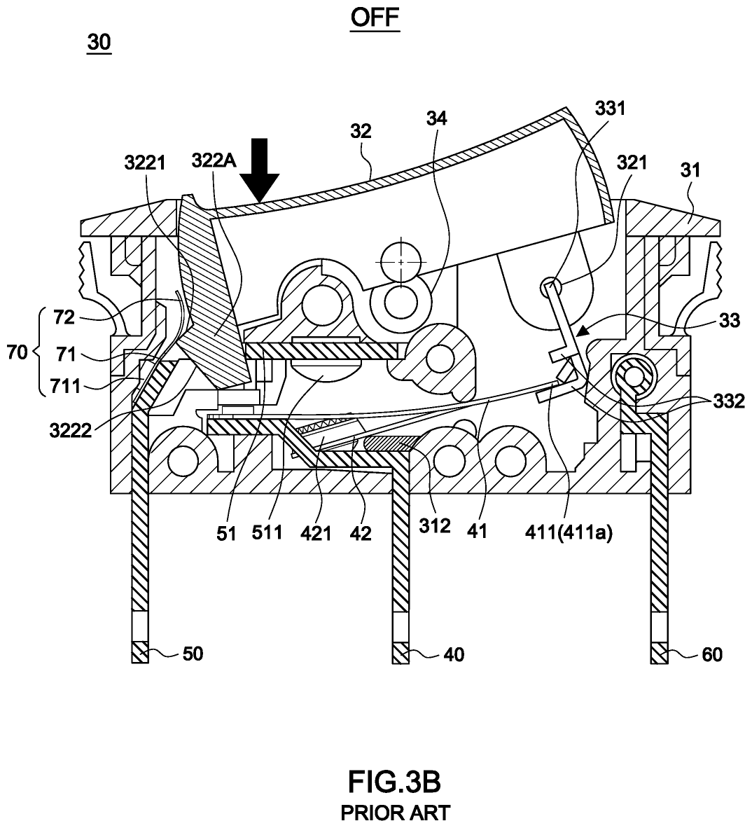

### DETAILED DESCRIPTION OF THE PREFERRED EMBODIMENT

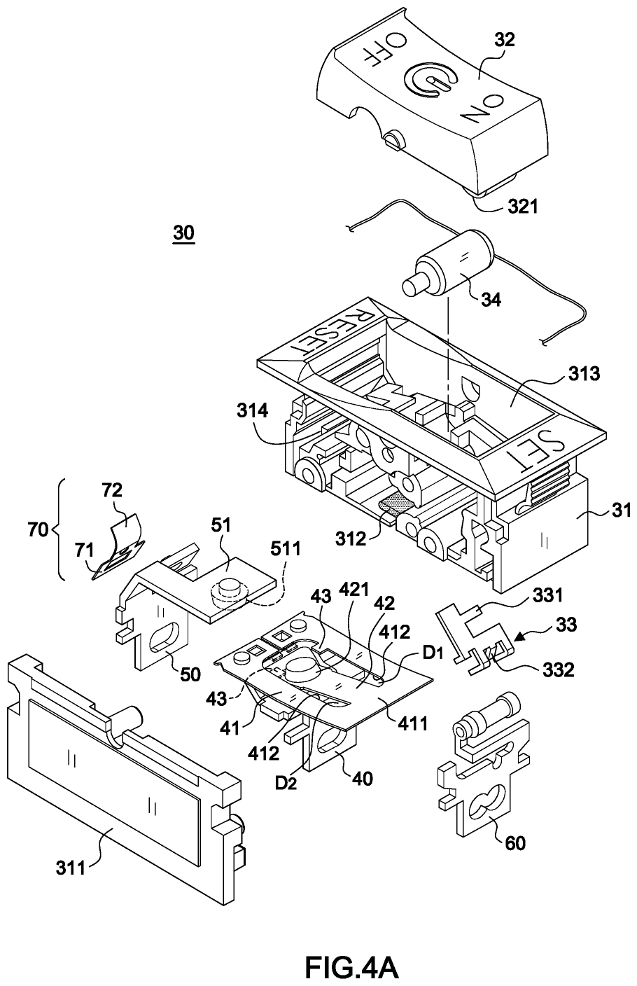

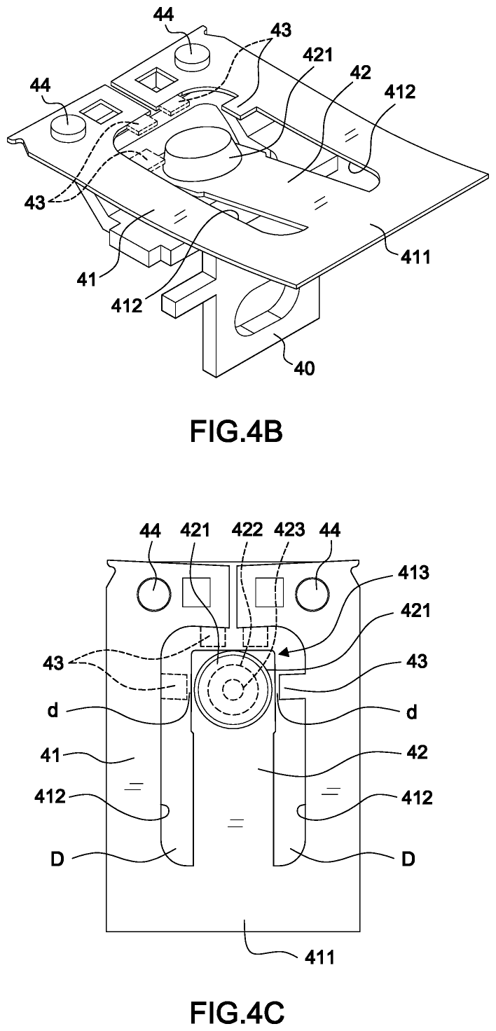

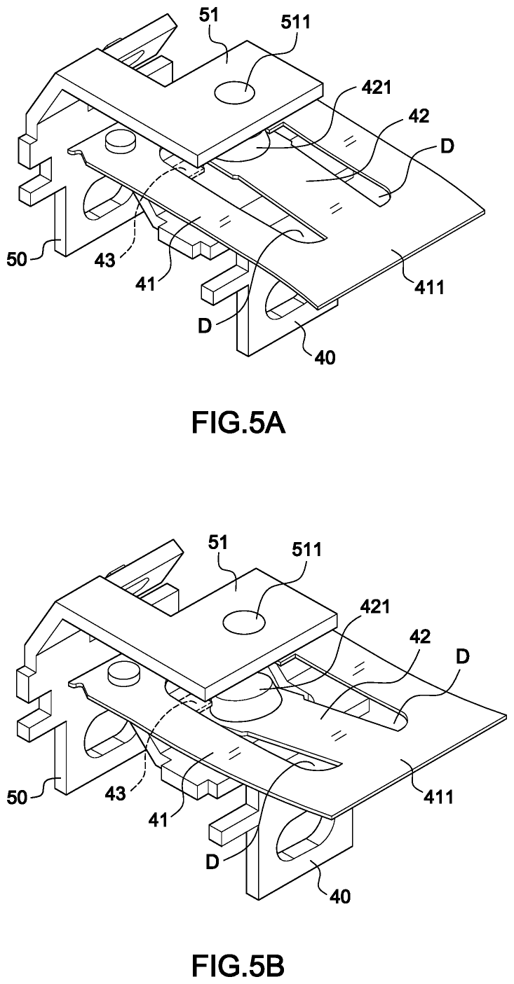

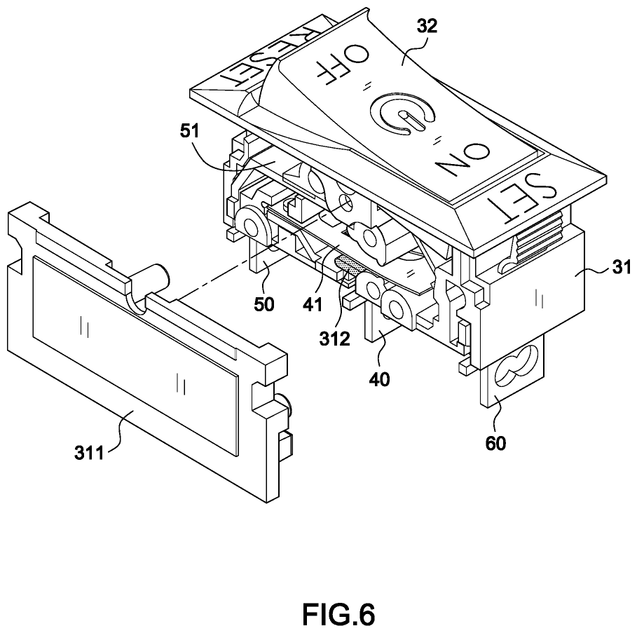

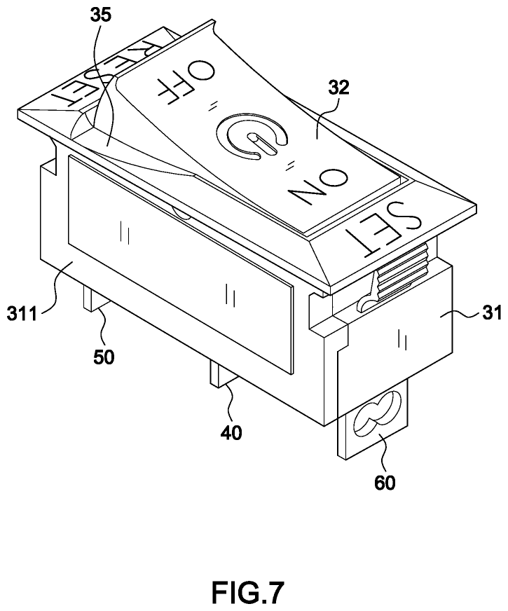

Referring to FIGS. 4A˜14B, the circuit breaker 30 of the present invention in preferred embodiment includes a housing 31, having a top opening 313 and a side opening 314, the top opening 313 has a switching component 32, in this embodiment, the switching component 32 is a seesaw lampshade, but the present invention is not limited to this; and the housing 31 further has a side cover 311 for the side opening 314. Below the switching component 32 further includes a neon lamp 34; And further has a first terminal 40 and a second terminal 50 arranged at a bottom section; in this embodiment, further includes a third terminal 60, but not limited to this. Wherein the fixed end 44 (which is the riveted point in this embodiment) of the first terminal 40 is connect to a binary alloy conductive plate 41, an inner side 412 of the binary alloy conductive plate 41 has a U-shaped hollow part 413, as FIG. 4C showing, the binary alloy conductive plate 41 has a spring leaf 42 extended from the middle of the inner side of the movable end 411, above the spring leaf 42 has a first connecting point 421 away from the movable end 411, and the second terminal 50 has a second connecting point 511 on a surface of an upper section 51 thereof disposed in correspondence with the first connecting point 421; As FIG. 4B showing, one end of the movable end 411 which away from the binary alloy conductive plate 41 is coupled to the first terminal 40 with two riveted points 44.

A moving rod 33 linking up a pivot hole 321 at the bottom of the switching component 32 with one end and the binary alloy conductive plate 41 with the other end, in this embodiment, the moving rod 33 includes: a horizontal rod 331 arranged at the upper section of the main body to set through the pivot hole 321 of the seesaw switching component 32; two brake plates 332 arranged at the lower section of the moving rod 33 and extended inward to push upward and downward for linking the movement of the movable end 411 of the first terminal 40; when the pivot hole 321 is pushed inward, making the first connecting point 421 contact the second connecting point 511 then consequently achieve conducting state (ON, SET end), and when current overload occurs, the binary alloy conductive plate 41 deformed due to high temperature, making the first connecting point 421 detach from the second connecting point 511 consequently achieve non conducting state (OFF), so as to form an overcurrent protection switch. Moreover, the moving rod 33 linking up the binary alloy conductive plate 41 includes: single ejector pin, double ejector pin, ejector with rotating seat, push-pull rod, pull rod.

Referring to FIGS. 4A˜4C, the main feature of the present invention is: the spring leaf 42 is formed at the movable end 411 of the binary alloy conductive plate 41 and extends from the inner side 412 thereof, and an equidistant space (D) is formed between the left and right inner sides 412 of the binary alloy conductive plate 41, so that when the current is overloaded, the spring leaf 42 can smoothly bounce and deform on the binary alloy conductive plate 41; furthermore, at the position relative to the first connecting point 421 of the U-shaped hollow part 413 of the binary alloy conductive plate 41 which closed to the fixed end 44, at least one lead 43 facing the first connecting point 421, and the inner end of the lead 43 is in a state of being close to but not in contact with the spring leaf 42 and the first connecting point 421, thereby forming an end receiving the electric arc (E) generated by the first connecting point 421 for making the electric arc (E) leave through the absorption channel formed by the closest lead 43; furthermore, referring to FIG. 4C, the equidistant space (D) between the inner sides 412 of the binary alloy conductive plate 41 and the spring leaf 42 is greater than the distance (d) between the inner end of the lead 43 and the spring leaf 42 and the first connecting point 421, so that the electric arc (E) generated by the first connecting point 421 absorbs and moves away in advance through the lead 43.

In this embodiment, the lead 43 is arranged at the right side of the binary alloy conductive plate 41, but not limited to this, it can also be located on the left side, as shown by the dotted line; or it can be located at the bottom of the U-shaped.

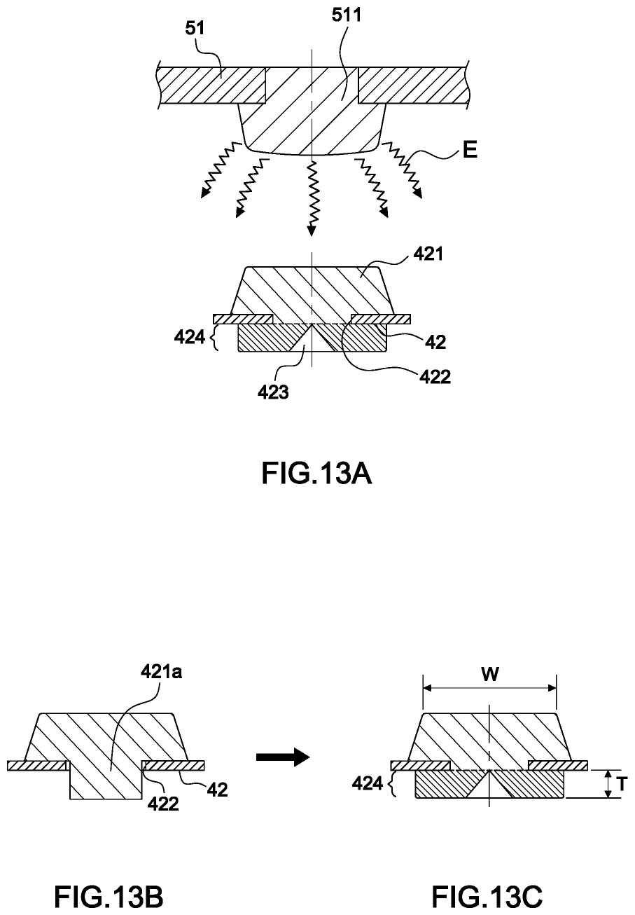

Referring to FIGS. 13A˜13C, in this embodiment, the first connecting point 421 is set through the through hole 422 by a rivet post 421a, then riveted into a parallel thin body with an outer diameter (W) greater than 3 mm and less than 4 mm, with a thickness (T) greater than 0.2 mm and less than 0.5 mm, then using a small punch-pin to squeeze to form a down concave arc surface 423 that can fill the inner diameter of the through hole 422. Whereby make the first connecting point 421 and the inner copper sheet and the upper and lower outer sheets of the spring leaf 42 form with different temperature deformation coefficients, then reinforce coating and enhance conductivity, so that it can withstand the short circuit deformation and avoid tripping delays to strengthen the stability of the combination and good conductivity, so that deformation and tripping can be accelerated in the event of a short circuit. Accordingly, because of the down concave arc surface 423 make the concave outer ring extends into a thin surface body 424, which can be flat against the spring leaf 42, and the outer edge of the thin surface body 424 has elastic compression and good conductivity, with an inner thin surface and an outer thick surface; so it can avoid conductive impedance to rise due to the riveting point surface being too small to suppressed after multiple bounce deformations during short circuit or switching.

In this embodiment, the present invention includes: an elastic leaf 70 arranged above the second terminal 50 and contacting the outside of a protruding block 322A for providing the switching component 32 with an elastic stopping force, whereby when switched to the ON position, the elastic leaf 70 is located on the inclined against surface 3222 at the lower part of the protruding block 322A; when switched to the OFF position, the elastic leaf 70 is located on the inclined pressing surface 3221 of the protruding block 322A, ensuring that the switching component 32 and the moving rod 33 are accurately positioned in the housing 31, thereby pushing the brake plates 332 at the bottom end of the moving rod 33 upward, causing the movable end 411 of the binary alloy conductive plate 41 pulled upwardly to the highest point and thereby cause the spring leaf 42 to bounce downwardly to the base plate 312 position, then the distance between the first connecting point 421 and the second connecting point 511 is maximized (Dmax) to ensure the safety of the insulation distance between the two connecting points 421, 511.

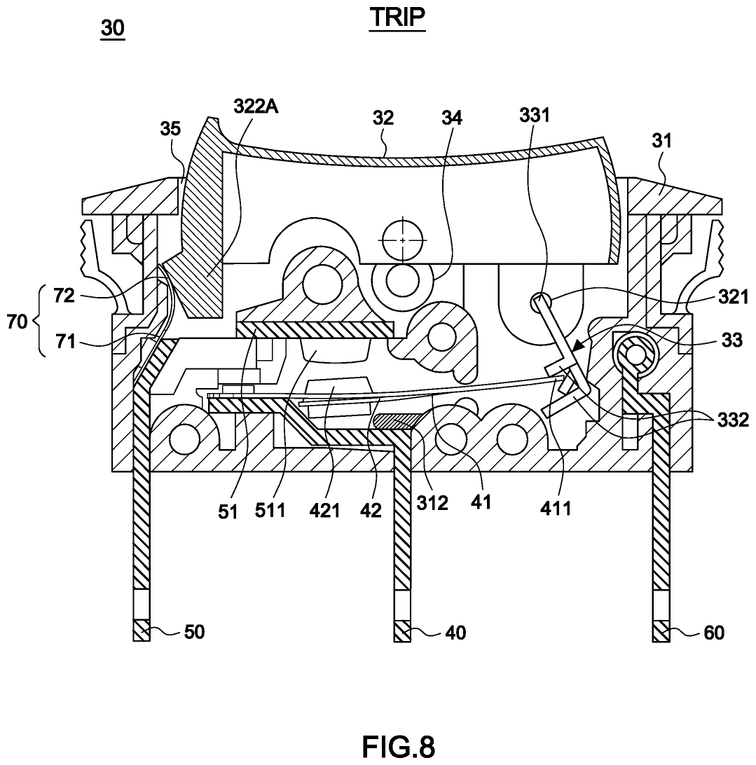

With the structure above mentioned, referring to FIG. 8, which show that the circuit breaker 30 is in a TRIP state; At this time, the elastic arc contact end 72 of the elastic leaf 70 is located on the inclined against surface 3222 of the lower part of the protruding block 322A and is close to the “peak” position.

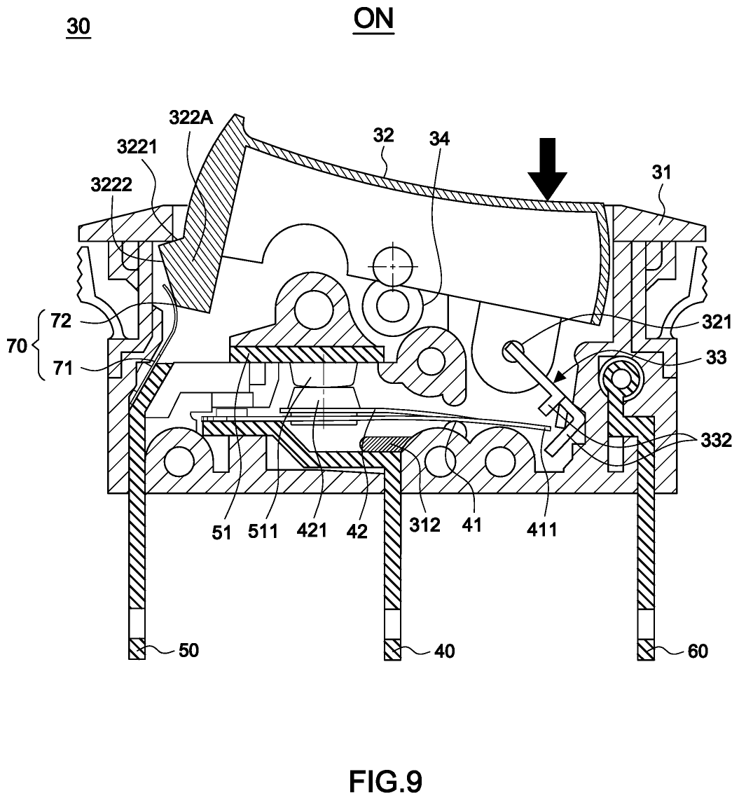

Referring to FIG. 9, which show that the circuit breaker 30 is in a ON state; At this time, the right side of the switching component 32 is pressed, and the protruding block 322A rises up; At this time, the elastic arc contact end 72 of the elastic leaf 70 is located below the inclined against surface 3222 which is at the “downhill” position of the lower edge of the protruding block 322A, and the upward pushing elastic force of the protruding block 322A can ensure that the seesaw switching component 32 is at the ON terminal position.

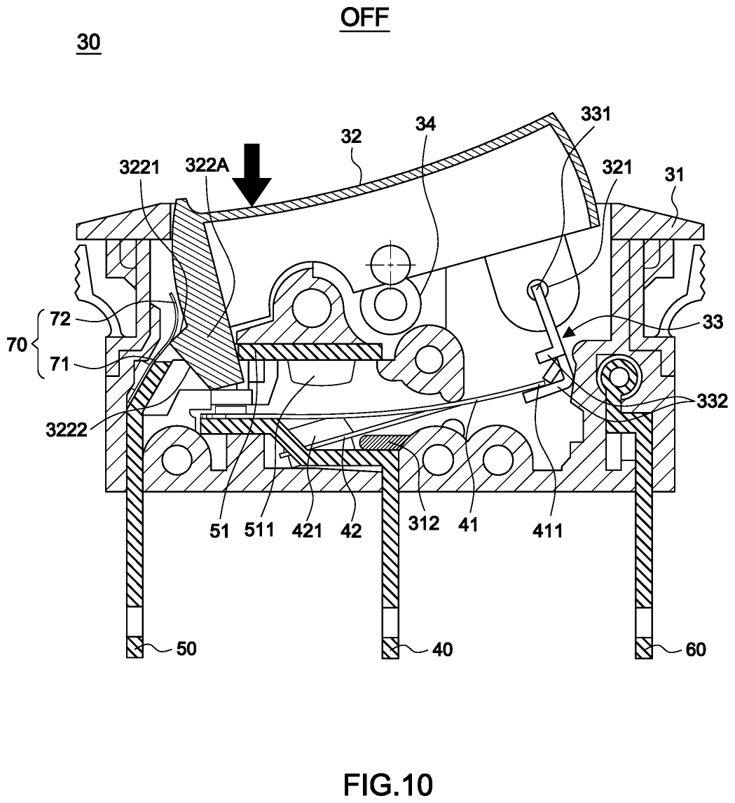

Referring to FIG. 10, which show that the circuit breaker 30 is in an OFF state; At this time, the left side of the switching component 32 is pressed, and the elastic arc contact end 72 of the elastic leaf 70 is located at the upper edge of the inclined pressing surface 3221 of the outside upper edge of the protruding block 322A which is located at the “valley” position of the protruding block 322A, and the downward pressing elastic force of the protruding block 322A can ensure that the switching component 32 is at the OFF terminal position.

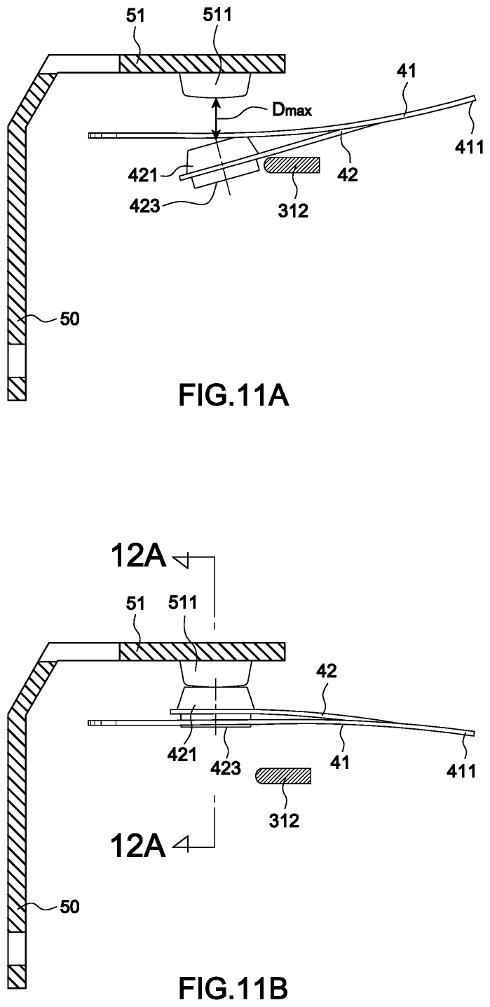

Also, FIG. 11A is the side view showing the first connecting point 421 and the second connecting point 511 during separation, when the spring leaf 42 bounce downwardly and deformed, the spring leaf 42 will be stopped by the base plate 312, so it will not bounce downward further, and make the distance between the first connecting point 421 and the second connecting point 511 is maximized (Dmax) to ensure the safety of the insulation distance between the two connecting points. Triangular and spring components can be used to change the operating stroke to a bidirectional three-stage control like MCCB and increase the insulation distance between the two contacts from 110V (1.6 mm) to the specified insulation distance of 220V (2.4 mm), within the same volume as the previously patented miniature switch MCB.

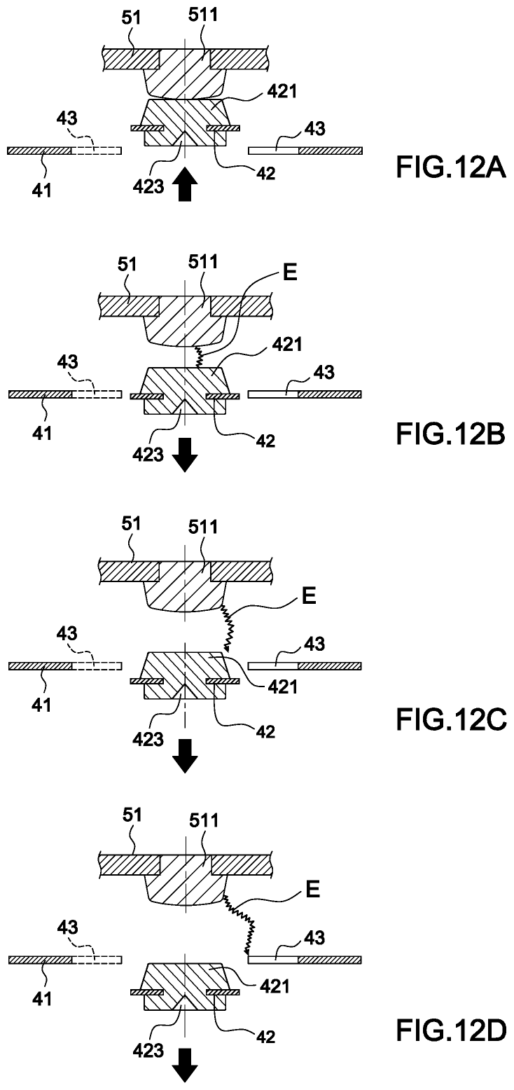

Referring to the FIGS. 12A˜12D, which illustrating the change of the electric arc (E) of the present invention when the first connecting point 421 and the second connecting point 511 are contacted or separated; wherein the FIG. 12A shows the first connecting point 421 and the second connecting point 511, when the electric arc (E) is not formed yet. The so-called “electric arc” is a form of electric discharge in gases. Electric discharge in gases is divided into two categories: self-sustaining discharge and non-self-sustaining discharge. Electric arc belongs to arc discharge of gas self-sustaining discharge. Tests have proven that when a circuit with a voltage exceeding 10V and a current exceeding 0.5 A is opened or closed in the atmosphere, a ball of extremely high temperature, extremely bright and capable energy will be generated in the gap between the two contact points. A gas that conducts electricity is called an electric arc. Due to the high temperature and strong light of the electric arc, it can be widely used in welding, smelting, chemical synthesis, strong light sources and space technology. For electrical appliances with contact points, since electric arcs are mainly generated when the contact points disconnect the circuit, the high temperature will burn the contact points and insulation. In serious cases, it may even cause phase short circuits and electrical appliance explosions, thus causing fires and endangering the safety of personnel and equipment. Therefore, the design of the present invention is to guide the electric arc generated when the first connecting point 421 and the second connecting point 511 are separated.

FIG. 12B shows a schematic diagram of the change of the electric arc (E) when the first connecting point 421 and the second connecting point 511 are just separated; At this time, the electric arc (E) starts to be generated between the first connecting point 421 and the second connecting point 511. FIG. 12C shows a schematic diagram of the electric arc (E) changing when the distance between the first connecting point 421 and the second connecting point 511 is extended; At this time, the electric arc (E) is stretched and looking for the nearest current channel. FIG. 12D shows a schematic diagram of the downward displacement of the first connecting point 421; At this time, the large current and high temperature electric arc (E) generated by it is closer to the lead 43 due to the displacement, so the electric arc (E) can be continuously guided and leave through the lead 43. When the electric arc (E) is instantly transferred to the lead 43, the electric arc (E) between the original two connecting points (421, 511) disappears, and the current conduction function is no longer available, which can prevent the binary alloy conductive plate 41 from thermal damage caused by continuous heating and continuous electric arc (E) damage to the first connecting point 421 and the second connecting point 511.

Therefore, it is clearly shown in FIGS. 12A to 12D that if there is no arrangement of the lead 43 to guide the electric arc (E) away, the electric arc (E) will be generated as shown in FIG. 13. The electric arc (E) cannot disappear on its own, since it cannot be received and guided, it will scatter in all directions to form a diffuse carbon ash layer, which will affect the dielectric test results and affect the bending characteristics of the binary alloy conductive plate 41 due to continuous heating and further causes the trip curve to drop.

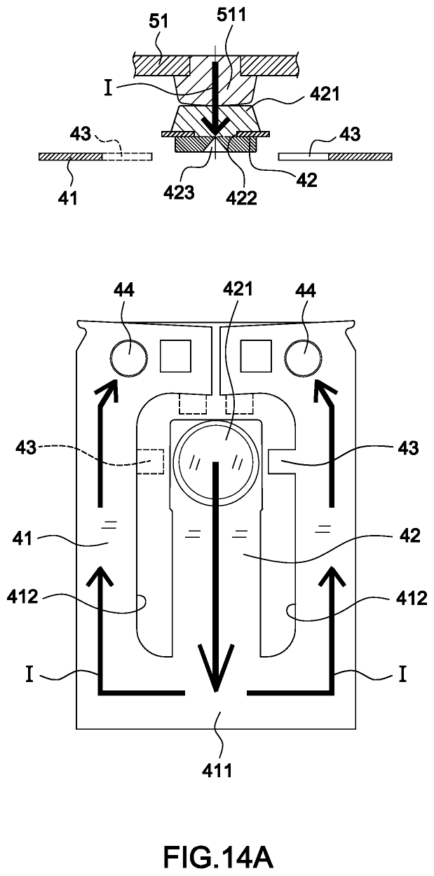

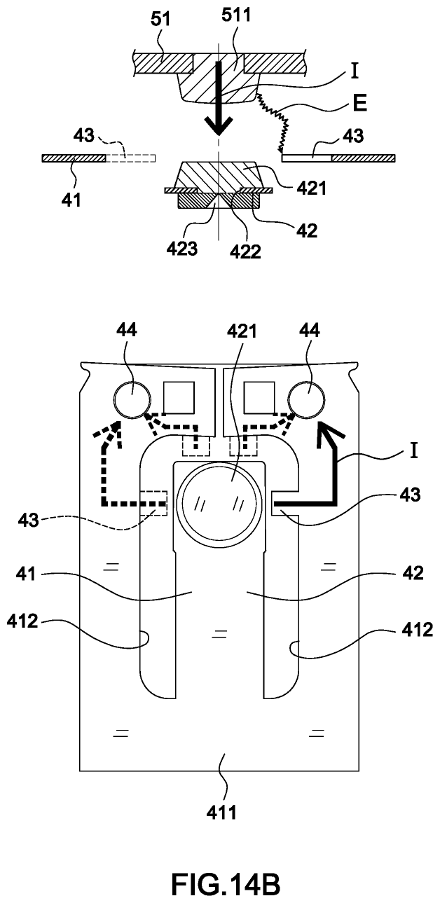

Referring to FIG. 14A, which shows a schematic diagram of the current (I) flow without generating the electric arc (E) when the first connecting point 421 and the second connecting point 511 are just in contact (as showing in FIG. 12A); at this time, the current (I) flow to the second connecting point 511→the first connecting point 421→the spring leaf 42→the movable end 411 of the binary alloy conductive plate 41→bidirectional rotation→both sides of the binary alloy conductive plate 41→two riveted points (fixed end) 44.

Referring to FIG. 14B, which shows a schematic diagram of the current (I) flow when the first connecting point 421 and the second connecting point 511 are separated (as showing in FIG. 12A); At this time, the electric arc (E) is closer to the lead 43, so the electric arc (E) can be continuously guided to the lead 43 to leave. In other words, when the electric arc (E) reaches the arc breaking distance during separation, the emitted electric arc (E) can smoothly leave through the nearest lead 43 channel, and will not explode and scatter in all directions. That is to say, when the electric arc (E) is instantly transferred to the lead 43, the original electric arc (E) of the first connecting point 421 and the second connecting point 511 is guided to the riveted point (fixed end) 44 to avoid the first connecting point 421 and the second connecting point 511 be damaged by the electric arc (E), and the condensed area of the binary alloy conductive plate 41 no longer has the function of current conduction, so that the binary alloy conductive plate 41 is not subject to stress decay caused by high temperature in short circuits, which can significantly reduce losses and enable it to pass the lossless short-circuit test.

Furthermore, the present invention uses the relative movement of movable connecting point and the lead 43 of the fixed position on the binary alloy conductive plate 41 to guide the electric arc (E). Therefore, there is no need to change the original connecting point separation structure, in addition to maintaining the required insulation distance, and not affect the continuity characteristics of electric arc deflection.

With the above-mentioned features, the present invention has the following effects that need further clarify:

1. The present invention does not need to change the structure of the original contact separation structure, the inner end of the lead 43 is close to but not in contact with the spring leaf 42 and the first connecting point 421, so that the electric arc (E) is leaved from the closest absorption channel formed by the lead 43, the original electric arc (E) between the two connecting points disappears, and there is no current conduction function, and there is no continuous electric arc (E) to damage the first connecting point 421, the second connecting point 511 and the binary alloy conductive plate 41. Therefore, it is a device that change the conductive position to smoothly discharge the current to eliminate the electric arc through the lead 43, which can shorten the occurrence time and distance of the electric arc to reduce the loss of the first connecting point 421 and the second connecting point 511 (silver points) and the binary alloy conductive plate 41 to achieve the purpose of short circuit without loss.

2. The present invention improves the two-stage switching operation of the miniature switch into a three-stage switching operation with bidirectional positioning, and further eliminates the need to add electromagnetic components without increasing the volume, and uses elastic force to eliminate the carbon ash structure; adding an original electric arc discharge device that having the arc remove ability to significantly reduce the electric arc (E) occurrence time and avoid the thermal damage of the binary alloy conductive plate 41, and improve the dielectric strength and voltage withstand characteristics after three short circuits; and the recalibration can exceed the highest level U3 level of Short-Circuit Test, and the calibration curve after three short circuits achieve 100% lossless characteristics.

Although particular embodiments of the invention have been described in detail for purposes of illustration, various modifications and enhancements may be made without departing from the spirit and scope of the invention. Accordingly, the invention is not limited except as by the appended claims.

What is claimed is:

1. An overload protection switch with short circuit protection function, comprising:
a housing, having a switching component on the top, a first terminal and a second terminal; the first terminal is connected to a binary alloy conductive plate, an inner side of the binary alloy conductive plate has a U-shaped hollow part, making the binary alloy conductive plate has a spring leaf, the spring leaf has a through hole for riveting a rivet post of a first connecting point, and the second terminal has a second connecting point on a surface of an upper section thereof disposed in correspondence with the first connecting point;
a moving rod arranged inside the housing and is driven by the switching component to link the binary alloy conductive plate for the first connecting point to contact the second connecting point, to thereby achieve a conducting state (ON), and the first connecting point disconnecting from the second connecting point responsive to occurrence of a current overload wherein the binary alloy conductive plate deforms due to high temperature, and thereby achieving a nonconducting state (OFF), to thereby form an overcurrent protection switch; wherein:
the spring leaf is formed at the movable end of the binary alloy conductive plate and extends from the inner side thereof, and an equidistant space is formed between the left and right inner sides of the binary alloy conductive plate, so that when the current is overloaded, the spring leaf can smoothly bounce and deform on the binary alloy conductive plate;
furthermore, at the position relative to the first connecting point of the U-shaped hollow part of the binary alloy conductive plate which closed to the fixed end, at least one lead facing the first connecting point, and the inner end of the lead is in a state of being close to but not in contact with the spring leaf and the first connecting point, thereby forming an end receiving the electric arc generated by the first connecting point for making the electric arc leave through the absorption channel formed by the closest lead;
furthermore, the equidistant space between the inner sides of the binary alloy conductive plate and the spring leaf is greater than the distance between the inner end of the lead and the spring leaf and the first connecting point, so that the electric arc (E) generated by the first connecting point absorbs and moves away in advance through the lead, since the distance from the second connecting point becomes farther during moving up and down.

2. The overload protection switch with a reverse restart switching structure as claimed in claim 1, wherein the first connecting point is set through the through hole by a rivet post, then riveted into a parallel thin body with an outer diameter greater than 3 mm and less than 4 mm, with a thickness greater than 0.2 mm and less than 0.5 mm, then using a small punch-pin to squeeze to form a down concave arc surface that can fill the inner diameter of the through hole.
